(19) United States
(12) Patent Application Publication
(10) Pub. No.: US 2026/0203427 A1
(43) Pub. Date: Jul. 16, 2026

(54) SYSTEMS AND METHODS FOR CONTROLLING DATA SHARING FOR SECURE LOGICAL STORAGE

(71) Applicant: The Toronto-Dominion Bank, Toronto (CA)

(72) Inventors: Vipul Kishore LALKA, Oakville (CA); Venkatanarayanan MAHALINGAM, Kitchener (CA); Shivani OBEROI, Toronto (CA); Ayda YORUKOGLU, Toronto (CA); Arnav Kumar MUNSHI, Toronto (CA)

(73) Assignee: The Toronto-Dominion Bank, Toronto (CA)

(21) Appl. No.: 19/016,573

(22) Filed: Jan. 10, 2025

(51) Int. Cl. G06F 21/62; G06F 21/78

(52) U.S. Cl. CPC G06F 21/62; G06F 21/78

(57) ABSTRACT

There is provided a method and a server for controlling data sharing between secure logical storages. A data access request from a first secure logical storage requests access to a portion of data from a second secure logical storage. The data access request is transmitted to a second computing device that provides a data access authorization thereby granting access to the portion of the data from the second secure logical storage to the first secure logical storage. A user interface element is provided on a first computing device that, when activated, accesses the portion of the data associated with the second secure logical storage within the first secure logical storage.

### TECHNICAL FIELD

The present disclosure relates to data security and, in particular, to systems and methods for controlling data sharing and manipulation for secure logical storage.

### BACKGROUND

Data sharing between accounts involves the account that controls the data authorizing the sharing by granting specific permissions to the other account. The authorizing account selects the data to be shared and sets access control policies, determining what the other account can do with the data, such as read-only or edit permissions. The data is shared through mechanisms like direct sharing features, APIs, or secure data transfer services. The other account is notified of the shared data and can access the data according to the permissions set. The authorizing account can monitor usage and audit access logs to ensure compliance, and if necessary, revoke access at any time. This process ensures secure and controlled data sharing between accounts.

### BRIEF DESCRIPTION OF THE DRAWINGS

Aspects are described in detail below, with reference to the following drawings:

FIG. 1 is a schematic operation diagram illustrating an operating environment;

FIG. 2 is a simplified schematic diagram showing components of a computing device;

FIG. 3 is a high-level schematic diagram of an example computer device;

FIG. 4A is a flowchart showing operations performed by a server for an association process that associates a second secure logical storage with a first secure logical storage in the situation where the two secure logical storages are co-located on the server;

FIG. 4B is a flowchart showing operations performed by the server for the association process that associates the second secure logical storage with the first secure logical storage in the situation where the first secure logical storage and the second secure logical storage are located on different servers;

FIG. 5 is a flowchart showing an example operation involving a conditional transfer of data from the second secure logical storage to the first secure logical storage;

FIG. 6 is a flowchart showing an example operation involving an automatic transfer of data from the second secure logical storage to the first secure logical storage;

FIG. 7A is a flowchart showing a revocation process executed by the first server in the instance where the first secure logical storage and the second secure logical storage reside on the same server; and

FIG. 7B is a flowchart showing a revocation process executed by the second server in the instance where the first secure logical storage and the second secure logical storage reside on different servers.

Like reference numerals are used in the drawings to denote like elements and features.

### DETAILED DESCRIPTION

According to an aspect, there is provided a server comprising: a communications module; a processor coupled to the communications module; and a memory coupled to the processor. The memory storing a plurality of processor-executable instructions which, when executed, may configure the processor to: receive, from a first computing device and via the communications module, a data access request to gain access to a portion of data from a second secure logical storage associated with a second secure logical storage holder by a first secure logical storage associated with a first secure logical storage holder; transmit the data access request to a second computing device via the communications module; receive a data access authorization from the second computing device via the communications module, the data access authorization thereby granting access to the portion of the data from the second secure logical storage to the first secure logical storage; and provide, on the first computing device, a user interface element that, when activated, accesses the portion of the data associated with the second secure logical storage within the first secure logical storage after the data access authorization.

The processor-executable instructions may further configure the processor to: receive, from the second computing device, a cumulative data transfer limit associated with the first secure logical storage within the second secure logical storage; and allocate a cumulative data transfer amount associated with the first secure logical storage within the second secure logical storage. The processor-executable instructions may further configure the processor to: receive, from the first computing device, a data transfer request of a first data amount from the second secure logical storage to the first secure logical storage. The processor-executable instructions may further configure the processor to: determine when adding the first data amount to the cumulative data transfer amount exceeds the cumulative data transfer limit; in response to the cumulative data transfer limit being exceeded, refuse the data transfer request; and in response to the cumulative data transfer limit not being exceeded, transfer the first data amount from the second secure logical storage to the first secure logical storage and add the first data amount to the cumulative data transfer amount. The processor-executable instructions may further configure the processor to: notify the first computing device and the second computing device about the first data amount being transferred from the second secure logical storage to the first secure logical storage.

According to another aspect, the processor-executable instructions may further configure the processor to: determine when a first data amount in the first secure logical storage is below a threshold; send, to the second computing device, a notification that the first data amount in the first secure logical storage is below the threshold; and request permission for a data transfer of a second data amount from the second secure logical storage to the first secure logical storage. The processor-executable instructions may configure the processor to: determine the second data amount to be added to the first data amount to be greater than or equal to the threshold.

According to yet another aspect, the processor-executable instructions may further configure the processor to: receive, from the second computing device, a data access revocation, from the second secure logical storage, removing access to the portion of the data associated with the second secure logical storage from the first secure logical storage. The processor-executable instructions may further configure the processor to: reset the cumulative data transfer amount according to a period.

According to another aspect, the processor-executable instructions further configure the processor to: determine an outlier data operation event associated with the second secure logical storage for the data transfer request noncompliant with the data access request and the data access authorization; and notify the first computing device of the outlier data operation event.

According to an aspect, there is provided a computer-implemented method comprising: receiving, from a first computing device and via a communications module, a data access request, to gain access to a portion of data from a second secure logical storage associated with a second secure logical storage holder by a first secure logical storage associated with a first secure logical storage holder; receiving, from a second computing device and via the communications module, a data access authorization, from the second secure logical storage, approving access to the portion of the data from the second secure logical storage to the first secure logical storage; and providing a user interface element on the first computing device, that, when activated, accesses the portion of the data associated with the second secure logical storage within the first secure logical storage after the data access authorization.

The computer-implemented method may further comprise: receiving, from the second computing device, a cumulative data transfer limit associated with the first secure logical storage within the second secure logical storage; and allocating a cumulative data transfer amount associated with the first secure logical storage within the second secure logical storage. The computer-implemented method may further comprise: receiving, from the first computing device, a data transfer request of a first data amount from the second secure logical storage to the first secure logical storage. The computer-implemented method may further comprise: determining when adding the first data amount to the cumulative data transfer amount exceeds the cumulative data transfer limit; in response to the cumulative data transfer limit being exceeded, refusing the data transfer request; and in response to the cumulative data transfer limit not being exceeded, transferring the first data amount to the second secure logical storage and add the first data amount to the cumulative data transfer amount. The computer-implemented method may further comprise: notifying the first computing device and the second computing device about the first data amount being transferred from the second secure logical storage to the first secure logical storage.

According to another aspect, the computer-implemented method may further comprise: determining when a first data amount in the first secure logical storage is below a threshold; sending, to the second computing device, a notification that the first data amount in the first secure logical storage is below the threshold; and requesting permission for a data transfer of a second data amount from the second secure logical storage to the first secure logical storage. The computer-implemented method may further comprise determine the second data amount to be added to the first data amount to be greater than or equal to the threshold.

According to yet another aspect, the computer-implemented method may further comprise: receiving, from the second computing device, a data access revocation, from the second secure logical storage, removing access to the portion of the data associated with the second secure logical storage from the first secure logical storage. The computer-implemented method may further comprise: resetting the cumulative data transfer amount according to a period. The computer-implemented method may further comprise: determining an outlier data operation event associated with the second secure logical storage for the data transfer request noncompliant with the data access request and the data access authorization; and notifying the first computing device of the outlier data operation event.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all the elements, and may include additional elements.

In the present application, the phrase “at least one of …and…” is intended to cover any one or more of the listed elements, including any one of the listed elements alone, any sub-combination, or all the elements, including any additional elements.

In data sharing applications, access to a secure logical storage may be a single authorizing account corresponding to an account holder, where the authorizing account is solely responsible for management of the secure logical storage. For example, the account holder, via the authorizing account, may transfer data to and/or from the secure logical storage. In some aspects, the secure logical storage may be shared between multiple authorizing accounts corresponding to different account holders. For example, any of the authorizing accounts of the secure logical storage may transfer data to and/or from the secure logical storage.

These two access management scenarios may not be optimal. For example, two different account holders via the authorizing accounts may want to perform some collaboration in the data sharing applications but maintain separation of their respective secure logical storages. Maintaining separate secure logical storages may prohibit such collaboration whereas sharing the secure logical storage among the two authorizing accounts may permit too much access to the secure logical storage by the different account holders. Using separate secure logical storages with a shared secure logical storage may causes technical inefficiencies. For example, the first authorizing account may have to login to the first secure logical storage and the second authorizing account may have to login to the second secure logical storage to facilitate management of the third shared logical storage. The multiple logins may use more network bandwidth and/or computing power than a single login to a single account. The multiple logins may be prone to security breaches than a single login. In other aspects, inability to precisely control access may not meet requirements of regulatory compliance.

The linking of a first account held by a first account holder and a second account held by a second account holder are described herein. In some instances, the first account holder may be able to view, via the first account, data pertaining to the second account. For example, upon the first account holder logging into the first account, a user interface of the first account may display a link or button that, upon being clicked or tapped, allows the first account holder to view data pertaining to the second account. The data pertaining to the second account may include balance, transaction history, upcoming payments, and/or expected deposits.

In some instances, the first account holder may, via the first account, manipulate data within the second account. For example, the first account may initiate a transfer of data from the second account to the first account. For example, the first account holder may, via the user interface of the first account, request that a first amount be transferred from the second account to the first account. Upon making the request, a notification may be sent to the second account that the request was made. Upon logging into the second account, the second authorizing account may permit the request, thereby allowing the first amount to be transferred to the first account.

In other instances, the second account holder may allow transfers to the first account without requiring permission from the second account holder so long as the transfers cumulatively abide by limit. For example, the second account holder may set a monthly limit for a cumulative amount that may be transferred to the first account without permission. When the first account holder requests a transfer exceeding the limit, permission of the second account holder may be required for the transfer to execute.

In some instances, the second account may receive notifications pertaining to the first account. For example, the first account may be notified of an unusual or suspicious transaction involving the second account. An unusual or suspicious transaction may be, without limitation, a large data transfer, a data transfer to or from a foreign jurisdiction, and/or an uncharacteristically large data accumulation.

The techniques described herein may apply to data sharing applications across a wide range of fields. For example, the techniques may apply to health information exchanges where patient data stored in secure logical storages associated with patients may enable healthcare providers to access the secure logical storages in accordance with a data access request and a data access authorization. In another example, the techniques may apply to smart grid data sharing where energy consumption data is stored in secure logical storages associated with energy consumers. The energy consumers may permit access to the energy consumption data according to data access requests and data access authorizations. In yet another example, the techniques may apply to financial collaborations where account holders in a financial institution may share data between secure logical storages to accomplish goals, such as two roommates sharing data regarding rent payment. In even yet another example, the techniques may apply to sharing of media, such as movies, audio files, etc., outside of the secure logical storage. One customer may request access to a portion of the data stored in another secure logical storage. The other customer may then authorize the data access in accordance with particular rules.

In some instances, the provider may offer customized products to the first account holder, or the second account holder based on data in the first account and the second account. For example, a financial institution may offer, to the second account holder, a supplemental credit card associated with a credit card held by the first account holder. In another example, the financial institution may offer a credit card with a higher credit limit to the first account holder when the higher credit limit is appropriate considering both the first and second accounts.

Access control is an element of database security. Various security controls may be implemented for a database to safeguard the data and any operations within the database from unauthorized access. An access control system for a database typically performs functions of authentication and access authorization to ensure that authorized users can gain access to the database. For example, a private database may store account data for a plurality of user accounts, and an access control system for the database may enforce security policies to restrict access to the user account data.

An access control system may enable users to define permissions for others to access their data. Users may specify which subjects are allowed to access their data and what privileges are given to those subjects. For example, account data for user accounts in a database may be accessible to those entities that have been assigned access rights by the users associated with the accounts. The access control system for the database may limit the scope of permitted access operations based on the permissions that are defined by the users.

In some contexts, users may wish to allow third-party applications access to their data in a protected database. For example, a user may provide consent for third-party applications on their device to gain direct access to their account data. The concept of “open banking” is an example of a secure, standardized release of private user data to third parties. Open banking allows users to grant third-party developers access to their banking data. Banks that allow such third-party access may benefit from having a larger ecosystem of applications and services that customers can use to access a wide range of banking functions. In particular, banks would not have to assume all responsibility for applications development by themselves; instead, third-party developers that are granted access to user data can develop applications that are suited for use by the banks’ customers.

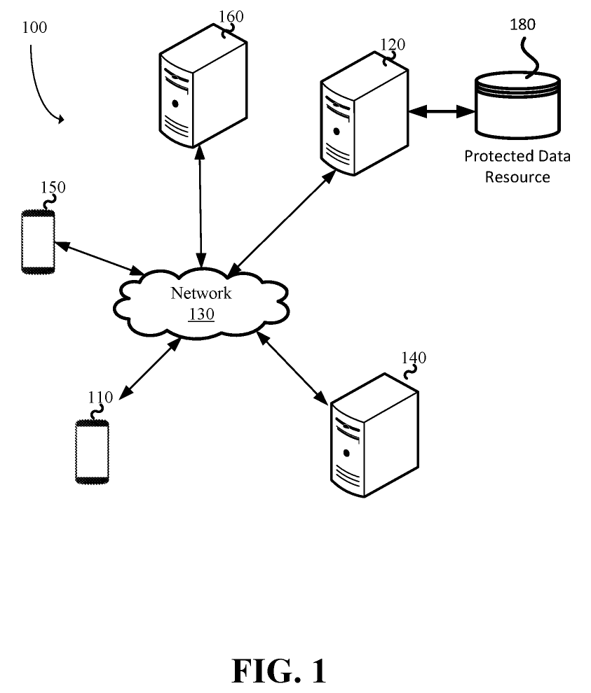

FIG. 1 is a schematic operation diagram illustrating an operating environment. FIG. 1 illustrates a system 100 for controlling data sharing for secure logical storage.

As shown, a first computing device 110, a second computing device 150, a first server 120, and/or a second server 160 may communicate via a network 130. The first computing device 110 may be referred to as a mobile computing device or a first remote computing device and may be associated with a first secure logical storage holder, such as a client, having a first secure logical storage associated with the first server 120. Similarly, the second computing device 150 may be referred to as a mobile computing device or a second remote computing device and may be associated with a second secure logical storage holder, such as a second client (being different than the first client), having a second secure logical storage associated with the first server 120. Put another way, the first secure logical storage holder is a different person than the second secure logical storage holder. In some aspects, the second secure logical storage may be associated with a second server 160 provided by different secure logical storage provider.

The first server 120 and/or the second server 160 may be referred to as access control servers and may be configured to control access to protected data stored within the first and second secure logical storage. The first server 120 and/or second server 160 may maintain a protected data resource 180 storing database records for a plurality of entities such as the first secure logical storage holder and/or the second secure logical storage holder. The protected data resource for the second server 160 is not shown to simplify FIG. 1. In at least some aspects, the first server 120 and/or the second server 160 may be provided by a financial institution which may maintain customer bank accounts. The protected data resource 180 that may be logically separated into one or more secure logical storages associated with one or more entities. The secure logical storages may store a data record that may, for example, reflect an amount of value stored in that particular secure logical storage associated with a secure logical storage holder. The first server 120 and/or the second server 160 may protect the secure logical storages using bank-grade security. The first server 120 and/or the second server 160 may be connected over the network 130 via a virtual private network and/or a bank-grade encryption protocol.

While FIG. 1 illustrates the first server 120 and the second server 160 as single servers, more than one such server may be engaged and connected through the network 130. Further, the first server 120 and the second server 160 may be connected to one or more data resources such as, for example, a computer system that includes one or more database servers, computer servers, and the like. The protected data resource 180 may provide, for example, an application programming interface (API) for a web-based system, operating system, database system, computer hardware, and/or software library.

The system 100 includes at least one of the application servers 140. The application server 140 may be associated with an application (such as a web or mobile application) that is resident on the first computing device 110 and/or the second computing device 150. The application may retrieve and/or instruct the application server 140 via an application programming interface (API). For example, the application server 140 may connect the first computing device 110 to a back-end system associated with the application. The application server 140 may be configured to perform, among others, user management, data storage, security, transaction processing, resource pooling, push notifications, messaging, and/or off-line support of the application. The application server 140 may be connected to the first computing device 110, the second computing device 150, the first server 120, and/or the second server 160 via the network 130.

The first computing device 110, the second computing device 150, the first server 120, the second server 160, and/or the application server 140 may be in geographically disparate locations. Put differently, the first computing device 110, the second computing device 150, the first server 120, the second server 160, and/or the application server 140 may be remote from one another.

The first computing device 110, the second computing device 150, the first server 120, the second server 160, and/or the application server 140 are computer systems. The first computing device 110 and/or the second computing device 150 may take a variety of forms including, for example, a mobile communication device such as a smartphone, a tablet computer, a wearable computer such as a head-mounted display or smartwatch, a laptop or desktop computer, or a computing device of another type. In some aspects, the first secure logical storage holder may operate the first computing device 110 to cause the first computing device 110 to perform one or more operations as described herein. Likewise, the second secure logical storage holder may operate the second computing device 150 to cause the second computing device 150 to perform one or more operations as described herein.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, a satellite network, or the like.

The protected data resource 180 stores secure data. In particular, the protected data resource 180 may include one or more secure logical storage locations that may store records for accounts that are associated with various entities. That is, the secure data may comprise account data for one or more specific entities. For example, a secure logical storage holder that operates the first computing device 110 may be associated with an account having one or more records in the protected data resource 180. In at least some embodiments, the records may reflect a quantity of stored resources that are associated with a secure logical storage holder. Such resources may include owned resources and/or borrowed resources (e.g. resources available on credit). The quantity of resources that are available to or associated with a secure logical storage holder may be reflected by a balance defined in an associated record.

For example, the secure data in the protected data resource 180 may include financial data, such as banking data (e.g. bank balance, historical transactions data, etc.) and investment data (e.g. portfolio information) for a secure logical storage holder. In particular, the first server 120 may be a financial institution (e.g. bank) server and the secure logical storage holder may be linked to a record of an account of the financial institution which operates the financial institution server. The financial data may, in some embodiments, include processed or computed data such as, for example, an average balance associated with an account, an average spending amount associated with an account, a total spending amount over a period, or other data obtained by a processing server based on account data for the secure logical storage holder.

In some embodiments, the protected data resource 180 may be a computer system that includes one or more database servers, computer servers, and the like. In some embodiments, the protected data resource 180 may comprise an application programming interface (API) for a web-based system, operating system, database system, computer hardware, or software library.

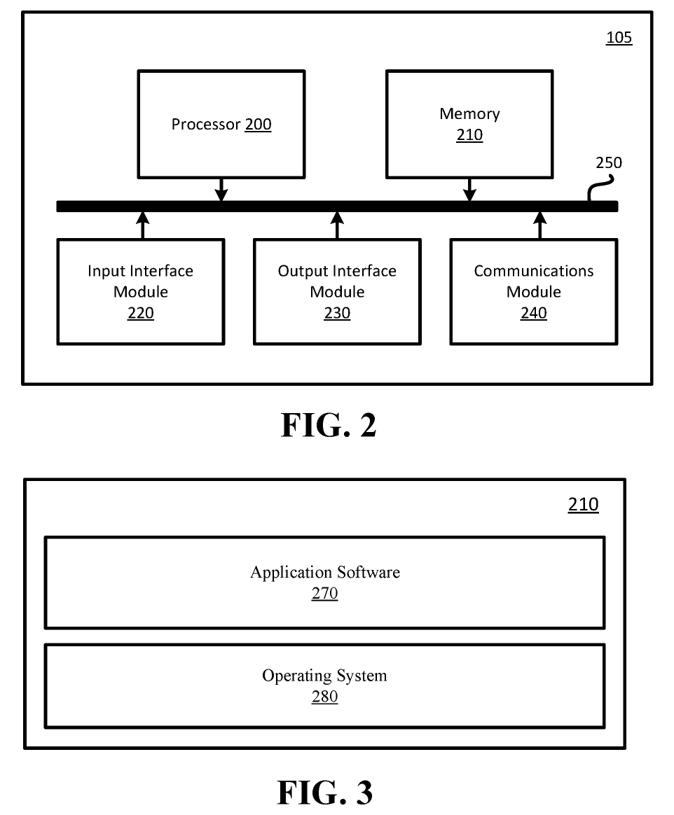

FIG. 2 is a high-level operation diagram of the computing system 105. In some aspects, the computing system 105 may be configured to be one or more of the first computing device 110, the second computing device 150, the first server 120, the second server 160, the application server 140, and/or the protected data resource 180. The computing system 105 includes a variety of modules. For example, as illustrated, the computing system 105, may include a processor 200, a computer-readable memory 210, an input interface module 220, an output interface module 230, and a communications module 240. As illustrated, the foregoing example modules of the computing system 105 are in communication over a bus 250.

The processor 200 is a hardware processor. The processor 200 may, for example, be one or more ARM, Intel x86, PowerPC processors or the like.

The computer-readable memory 210 allows data and/or instructions to be stored and retrieved. The computer-readable memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the computing system 105. The computer-readable memory 210 may comprise a storage module for storing and retrieving data. Additionally or alternatively, the storage module may be used to store and retrieve data from persisted storage that may not be accessible via the computer-readable memory 210. In some aspects, the storage module may be used to store and retrieve data in a database. A database may be stored in persisted storage. Additionally or alternatively, the storage module may access data stored remotely such as, for example, as may be accessed using a local area network (LAN), wide area network (WAN), personal area network (PAN), and/or a storage area network (SAN). In some aspects, the storage module may access data stored remotely using the communications module 330. In some aspects, the storage module may be omitted and its function may be performed by the computer-readable memory 210 and/or by the processor 200 in concert with the communications module 240 such as, for example, when data is stored remotely. The storage module may also be referred to as a data store.

The input interface module 220 allows the computing system 105 to receive input signals. Input signals may, for example, correspond to input received from a user. The input interface module 220 may serve to interconnect the computing system 105 with one or more input devices. Input signals may be received from input devices by the input interface module 220. Input devices may, for example, include one or more of a touchscreen input, keyboard, trackball, voice command interface, or the like. In some aspects, all or a portion of the input interface module 220 may be integrated with an input device. For example, the input interface module 220 may be integrated with one of the input devices.

In some aspects, the input interface module 220 may comprise one or more image capture modules and/or one or more sensor modules. The image capture module may be or may include a camera. The image capture module may be used to obtain image data, such as images. The image capture module may be or may include a digital image sensor system as, for example, a charge coupled device (CCD) or a complementary metal–oxide–semiconductor (CMOS) image sensor. The sensor module may be a sensor that generates sensor data based on a sensed condition. By way of example, the sensor module may be or include a location subsystem which generates location data indicating a location of the computing system 105. The location may be the current geographic location of the computing system 105. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The output interface module 230 allows the computing system 105 to provide output signals. Some output signals may, for example allow provision of output to a user. The output interface module 230 may serve to interconnect the computing system 105 with one or more output devices. Output signals may be sent to output devices by an output interface module 230. Output devices may include, for example, a display screen such as, for example, a liquid crystal display (LCD), a touchscreen display. Additionally, or alternatively, output devices may include other output devices such as, for example, a speaker, indicator lamps (such as for, example, light-emitting diodes (LEDs)), and printers. In some aspects, all or a portion of the output interface module 230 may be integrated with an output device. For example, the output interface module 230 may be integrated with one of the output devices.

The communications module 240 allows the computing system 105 to communicate with other electronic devices and/or various communications networks. For example, the communications module 240 may allow the computing system 105 to send or receive communications signals. Communications signals may be sent and/or received according to one or more protocols or according to one or more standards. For example, the communications module 240 may allow the computing system 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 240 may allow the computing system 105 to communicate using near-field communication (NFC), via Wi-Fi (TM), using Bluetooth (TM) or via some combination of one or more networks or protocols. In some aspects, all or a portion of the communications module 240 may be integrated into a component of the computing system 105. For example, the communications module 240 may be integrated into a communications chipset.

Software comprising instructions is executed by the processor 200 from a computer-readable medium. For example, software may be loaded into random-access memory from persistent storage of computer-readable memory 210. Additionally, or alternatively, instructions may be executed by the processor 200 directly from read-only memory of computer-readable memory 210.

FIG. 3 depicts a simplified organization of software components stored in the computer-readable memory 210 of the computing system 105. As illustrated these software components include an operating system 280 and an application 270. The operating system 280 is software. The operating system 280 allows the application 270 to access the processor 200, the computer-readable memory 210, the input interface module 220, the output interface module 230 and/or the communications module 240. The operating system 280 may be, for example, Apple’s iOS^{TM}, Google’s Android^{TM}, Linux^{TM}, Microsoft’s Windows^{TM}, or the like.

The application 270 adapts the computing system 105, in combination with the operating system 280, to operate as a device performing particular functions. For example, the application 270 may cooperate with the operating system 280 to adapt a suitable aspect of the computing system 105 to operate as the first computing device 110, the second computing device 150, the first server 120, the second server 160, the application server 140, and/or the protected data resource 180.

While an application 270 is illustrated in FIG. 3 as a single application, in operation, the computer-readable memory 210 may include more than one application 270, and the applications 270 may perform different operations. For example, in aspects where the computing system 105 is functioning as the first computing device 110 and/or the second computing device 150, the application 270 may comprise a value transfer application which may, for example, be a personal banking application. The value transfer application may be configured for secure communications with the first server 120 and/or the second server 160 and may provide various banking functions such as, for example, display of account balances, transfers of value (e.g. bill payments, money transfers), and other account management functions.

The on-device application data may include one or more of a list of applications installed on the first computing device 110 and/or the second computing device 150, levels of permission granted to the installed applications, internet search history data, and/or activity data indicating activity performed on the first computing device 110 and/or the second computing device 150. The monitoring application may be installed on the first computing device 110 and/or the second computing device 150 for a period to allow the first server 120 to obtain the on-device application data. The monitoring application may be deleted from the first computing device 110 and/or the second computing device 150 automatically or manually. The monitoring application, when installed on the computing system 105, may be configured like a Virtual Private Network (VPN) such that one or more other applications installed on the first computing device 110 and/or the second computing device 150 may send and receive data through the monitoring application.

By way of further example, in at least some aspects in which the computing system 105 functions as the first computing device 110 and/or the second computing device 150, the applications 270 may include a web browser, which may also be referred to as an Internet browser. In at least some such embodiments, the first server 120 may be a web server that may serve one or more of the interfaces described herein. The web server may cooperate with the web browser and may serve an interface when the interface is requested through the web browser. For example, the web server may serve as a mobile banking interface.

By way of further example, in at least some aspects in which the computing system 105 functions as the first computing device 110, the applications 270 may include an electronic messaging application. The electronic messaging application may be configured to display a received electronic message such as an email message, short messaging service (SMS) message, or a message of another type.

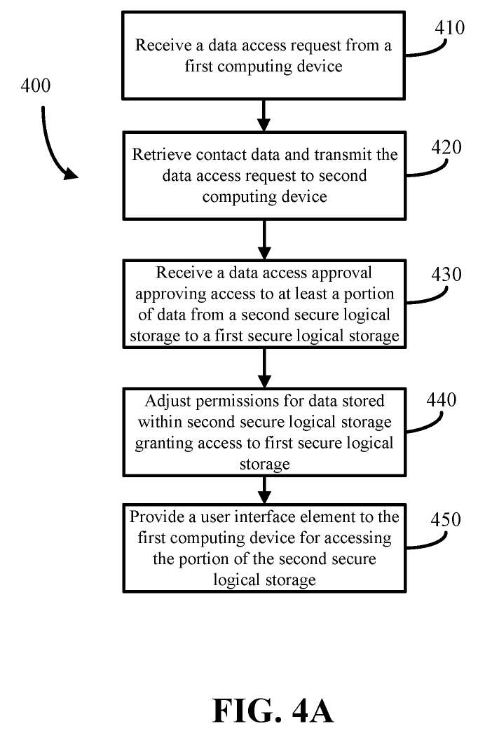

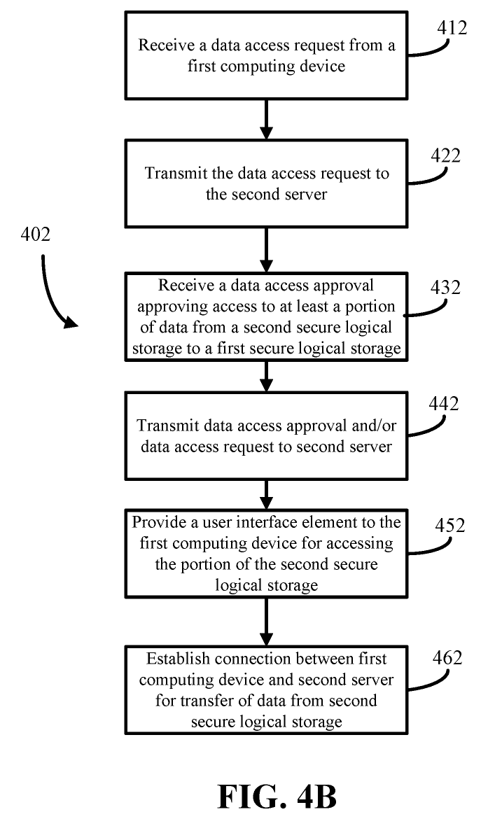

Aspects of operations performed by the first server 120 may be described with reference to FIGS. 4-6. As shown in FIG. 4A, an association process 400 may be performed that associates the second secure logical storage with the first secure logical storage in the situation where the two secure logical storages are co-located on the first server 120. The association process 400 may be performed by the first server 120. For example, the computer-executable instructions stored in memory of the first server 120 may, when executed by a processor of the first server 120, configure the first server 120 to perform the association process 400 or a portion thereof.

The association process 400 begins when the first server 120 receives a data access request, via the communications module and from a resource management application executing on the first computing device 110 (at step 410). The data access request may include a first identifier corresponding to the first secure logical storage and a second identifier corresponding to the second secure logical storage. The data access request may include requests for read-only access or may request that future operations to be permitted on the data stored in the second secure logical storage. The operations may include transfers of data, storage of data, altering of data, conditional transfers of data, automatic transfers of data, and/or periodic transfers of data. In some aspects, the data access request may request more operations than approved by the second secure logical storage holder associated with the second secure logical storage.

In some aspects, the second identifier may be retrieved from the second computing device 150 by the first computing device 110. For example, the first computing device 110 may capture a quick-response code (QR code) associated with the second identifier using a camera of the first computing device 110. The QR code may be displayed on a display of the second computing device 150 or the QR code may be printed on paper. In another example, the first computing device 110 may receive a transmission from the second computing device 150, such as by Wi-Fi, Bluetooth, near-field communication (NFC), and/or other wireless communication protocol.

The first server 120 may retrieve contact data associated with the second secure logical storage and prepare a notification to transmit the data access request based on the contact data at step 420. In some aspects, the first server 120 may verify that the contact data of the first secure logical storage holder corresponds, at least in part, to the contact data of the second secure logical storage holder. For example, when the two holders are roommates, the address data should correspond to each other. In another example, when the two holders are family, the address data should correspond to each other. In the aspect where the first secure logical storage and the second secure logical storage are both located on the first server 120, the first server 120 may merely retrieve the contact data directly from the second secure logical storage. For example, the first server 120 may retrieve an email, a phone number, and/or a device token and transmit the notification for the data access request to the email, phone number and/or the device token. In the aspect, the notification may be provided to a third-party push notification service, such as Apple Push Notification Service (APN) for iOS and/or Firebase Cloud Messaging (FCM) for Android. The push notification service may route the notification to the second computing device 150 via the network 130. In some aspects, the transmission of the notification may be encrypted and/or digitally signed. The first server 120 may add the data access request to an internal queue of unapproved requests waiting for authorization. In some aspects, the data access request may expire after a predetermined period, such as 1-week, 1-month, or otherwise as determined by one or more security measures.

In another aspect, the first server 120 may identify secure logical storages related to each other based on the same contact data between the secure logical storage. In response, the first server 120 may prepare data access requests for the related secure logical storages and transmit a the data access requests to each of the holders of the related secure logical storages.

On receipt of the notification, the second computing device 150 may present the notification on the display (e.g. the output interface module 230) via the email message, text message, and/or the push notification prompting the second secure logical storage holder for authorization. The presented notification may wait until input is provided on a touchscreen or other user interface (e.g. the input interface module 220) to approve or refuse the data access request. When the second secure logical storage holder refuses the data access request, the second computing device 150 transmits a refusal message to the first server 120 via the communications module 240 and the network 130. The first server 120 may remove the data access request from the internal queue and/or transmit a refusal notification to the first computing device 110 to notify the first secure logical storage holder of the refusal. The first computing device 110 may present the notification of the refusal on its display (e.g. the output interface module 230). When the second secure logical storage holder approves the data access request, the second computing device 150 transmits a data access authorization to the first server 120 via the communications module 240 and the network 130. The first server 120 receives the data access authorization at step 430 from the second computing device 150.

The first server 120 may adjust one or more permissions for at least a portion of the data stored within for the second secure logical storage thereby granting access to the first secure logical storage at step 440. In some aspects, the first server 120 may store the data access request and the data access authorization within the first secure logical storage.

At step 450, the first server 120 may provide one or more instructions over the network 130 to the resource management application executing on the first computing device 110. The instructions may provide a user interface element to the first computing device 110 for accessing and/or operating on the portion of the data of the second secure logical storage. In response to activation of the user interface element, the first server 120 may retrieve the data access authorization and/or the data access request from the first secure logical storage and, based on the data access authorization and/or the data access request, may retrieve the data from the second secure logical storage. The data may be transferred via the network 130 to the first computing device 110 for presentation on the display to the first secure logical storage holder. The first computing device 110 may, using the user interface elements, operate on the data and/or provide instructions to the first server 120 to operate on the data as permitted by the data access authorization. The operations may include transfers of data, storage of data, altering of data, conditional transfers of data, automatic transfers of data, and/or periodic transfers of data.

Turning to FIG. 4B, the association process 402 when the first secure logical storage and the second secure logical storage are located on different servers, such as the first server 120 and the second server 160, begins when the first server 120 receives a data access request, via the communications module and from a resource management application executing on the first computing device 110 (at step 412). The data access request may include a first identifier corresponding to the first secure logical storage and a second identifier corresponding to the second secure logical storage. The data access request may include requests for read-only access or may request that future operations to be permitted on the data stored in the second secure logical storage. The operations may include transfers of data, storage of data, altering of data, conditional transfers of data, automatic transfers of data, and/or periodic transfers of data. In some aspects, the data access request may request more operations than approved by the second secure logical storage holder associated with the second secure logical storage.

As previously described, in some aspects, the second identifier may be retrieved from the second computing device 150 by the first computing device 110. For example, the first computing device 110 may capture a quick-response code (QR code) associated with the second identifier using a camera of the first computing device 110. The QR code may be displayed on a display of the second computing device 150 or the QR code may be printed on paper. In another example, the first computing device 110 may receive a transmission from the second computing device 150, such as by Wi-Fi, Bluetooth, near-field communication (NFC), and/or other wireless communication protocol.

In some aspects, the first server 120 may request the contact data from the second server 160 and prepare the notification as previously described. In some other aspects shown particularly in FIG. 4B, the first server 120 may provide the data access request to the second server 160 at step 422 and the second server 160 may retrieve the contact data associated with the second secure logical storage and prepare the notification to transmit the data access request based on the contact data in a similar manner as described for FIG. 4A. By providing the notification from the second server 160, the second secure logical storage holder may trust the notification more than receiving the notification from the first server 120. The first server 120 may add the data access request to an internal queue of unapproved requests waiting for authorization. In some aspects, the data access request may expire after a predetermined period, such as 1-week, 1-month, or otherwise as determined by one or more security measures.

On receipt of the notification from the second server 160, the second computing device 150 may present the notification on the display (e.g. the output interface module 230) via the email message, text message, and/or the push notification prompting the second secure logical storage holder for authorization. The presented notification may wait until input is provided on a touchscreen or other user interface (e.g. the input interface module 220) to approve or refuse the data access request. When the second secure logical storage holder refuses the data access request, the second computing device 150 transmits a refusal message to the first server 120 and/or the second server 160 via the communications module 240 and the network 130. The first server 120 may remove the data access request from the internal queue and/or transmit a refusal notification to the first computing device 110 to notify the first secure logical storage holder of the refusal. The first computing device 110 may present the notification of the refusal on its display (e.g. the output interface module 230). When the second secure logical storage holder approves the data access request, the second computing device 150 transmits a data access authorization to the first server 120 and/or the second server 160 via the communications module 240 and the network 130 and the first server 120 and/or the second server 160 receives the data access authorization at step 432.

At step 442, the first server 120 may transmit the data access request and/or the data access authorization to the second server 160. The second server 160 may adjust one or more permissions for at least a portion of the data stored within the second secure logical storage granting access to the first secure logical storage on the first server 120. In some aspects, the first server 120 and the second server 160 may set up a secure connection therebetween, such as a VPN, for transferring the at least a portion of the data from the second secure logical storage to the first secure logical storage. In some aspects, the first server 120 may store the data access request and the data access authorization within the first secure logical storage and the second server 160 may store the data access request and the data access authorization within the second secure logical storage.

In some aspects, the first server 120 may perform a security analysis of the data access request, the data access authorization, and/or the data transfer to determine an outlier data operation event. The data transfer requests may be compared to the stored data access request and/or the data access authorization to determine noncompliant data transfers (e.g. data transfers not covered by the data access request and/or the data access authorization). In instances where the data access request and/or the data access authorization fails the security analysis, the data transfer is refused and the first computing device 110 and/or the second computing device 150 may be notified. In other aspects, the data access request and/or the data access authorization may be reviewed by the security analysis. For instance, when many data access requests and/or the data access authorizations for the same secure logical storage are received in a short period (e.g. in an hour, day, etc.), the secure logical storage may be flagged for fraudulent data access requests and/or the data access authorizations. The secure logical storage may be provided to a fraud prevention system.

In some aspects, the first server 120 may retrieve contact data for the first secure logical storage and the second secure logical storage for comparison. The data access request and/or the data access authorization may provide the relationship between the two holders. When the contact data does not match, a fraudulent data access request and/or a fraudulent data access authorization may have occurred. For example, when the relationship indicates family or roommates, the address data should be the same between first secure logical storage and the second secure logical storage.

At step 452, the first server 120 may provide one or more instructions over the network 130 to the resource management application executing on the first computing device 110. The instructions may provide a user interface element to the first computing device 110 for accessing the portion of the data of the second secure logical storage on the second server 160.

In response to activation of the user interface element, the first server 120 may retrieve the data access authorization and/or the data access request from the first secure logical storage and, based on the data access authorization and/or the data access request, may retrieve the data from the second secure logical storage on the second server 160. In some aspects, the data from the second secure logical storage may be retrieved on a periodic basis and/or on-demand. The data may be transferred via a secure connection over the network 130 to the first computing device 110 for presentation on the display to the first secure logical storage holder. In some aspects, the first server 120 may set up the secure connection to the second server 160 to retrieve the data from the second secure logical storage.

In other aspects such as step 462, the first server 120 may transmit instructions to the first computing device 110 to set up a direct secure connection from the first computing device 110 to the second server 160 and the first computing device 110 may retrieve and/or operate on the allowed data directly from the second secure logical storage on the second server 160. The first computing device 110 may, using the user interface elements, operate on the data and/or provide instructions to the second server 160 to operate on the data as permitted by the data access authorization. The second server 160 receives the operations and may verify that the operation is permitted by the data access authorization and/or the data access request. When the operation is allowed, the second server 160 may perform the operation on the second secure logical storage. The operations may include transfers of data, storage of data, altering of data, conditional transfers of data, automatic transfers of data, and/or periodic transfers of data.

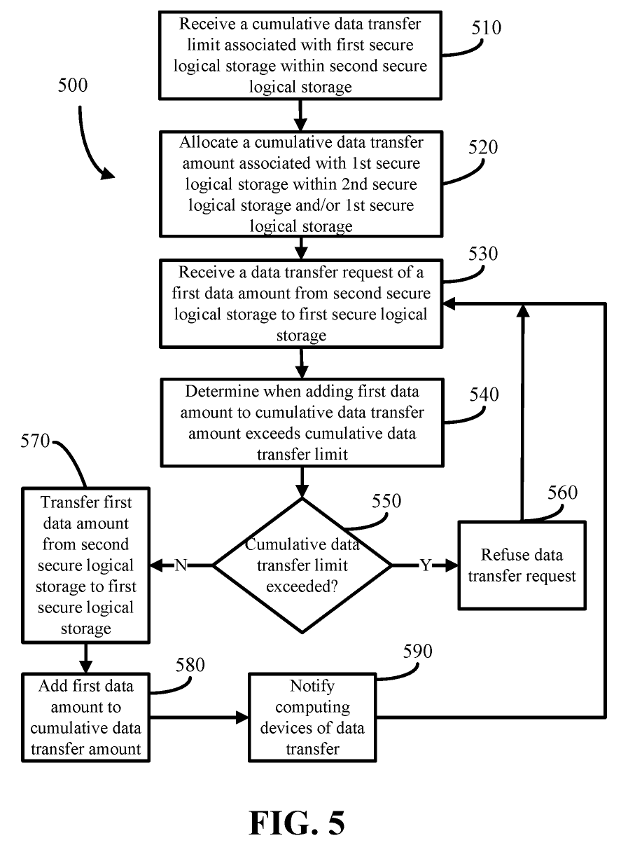

An example operation 500 is presented in FIG. 5 and involves a conditional transfer of data. In this example, generally, a cumulative data transfer limit may restrict an amount of data transfer from the second secure logical storage to the first secure logical storage. The first server 120 may receive, at step 510, a cumulative data transfer limit as part of the data access authorization to access the second secure logical storage from the first secure logical storage. The cumulative data transfer limit may be a limit on an amount of data to be transferred from the second secure logical storage to the first secure logical storage. When the cumulative data transfer limit is reached, any further data transfers from the second secure logical storage to the first secure logical storage may be prohibited by the first server 120.

The first server 120 may allocate a cumulative data transfer amount within the second secure logical storage corresponding to transfers to the first secure logical storage at step 520. In aspects when the second secure logical storage is located on the second server 160, the first server 120 may allocate the cumulative data transfer amount within the first secure logical storage as the first server 120 has more direct control of the first secure logical storage. In this instance, the second server 160 may also have the cumulative data transfer amount allocated in the second secure logical storage. In some aspects, the cumulative data transfer amount may be reset according to a schedule, such as daily, weekly, monthly, quarterly, biannually, etc. When the cumulative data transfer amount is reset, the cumulative data transfer amount is set to zero.

The first server 120 may receive one or more data transfer requests at step 530. The data transfer requests may specify a first data amount to be transferred from the second secure logical storage to the first secure logical storage. In some aspects, the first server 120 may retrieve a current data amount within the second secure logical storage and when the data amount is less than the first data amount, the transfer may be refused. In some aspects, the first server 120 may perform a security analysis of the data transfer request, the data access request, and/or the data access authorization to determine one or more outlier data operation events. In instances where the data transfer request fails the security analysis, the data transfer request is refused and the first computing device 110 and/or the second computing device 150 may be notified.

At step 540, the first server 120 may determine when adding the first data amount to the cumulative data transfer amount exceeds the cumulative data transfer limit specified in the data access authorization. When the cumulative data transfer limit is exceeded at step 550, the first server 120 may refuse the data transfer request at step 560. The refusal may involve sending a notification to the resource management application executing on the first computing device 110 and/or the second computing device 150. In aspects where the second computing device 150 does not have the resource management application, the second computing device 150 may receive a message, such as by email, text, etc. from the first server 120. In some aspects, the second server 160 may transmit the notification to the resource management application executing on the second computing device 150. The example operation 500 may continue back at step 530 following the refusal.

In other aspects, the data transfer amount may be set to the cumulative data transfer limit, and the first data amount may be subtracted from data transfer amount rather than added at step 540. When the data transfer amount reaches or is less than zero, the cumulative data transfer limit is exceeded at step 550.

When the cumulative data transfer limit is not exceeded (e.g. is less than or equal to the cumulative data transfer limit), the first server 120 may transfer the first data amount from the second secure logical storage to the first secure logical storage. When the first secure logical storage and the second secure logical storage are co-located on the first server 120, the transfer may be performed solely by the first server 120. When the first secure logical storage and the second secure logical storage are located on different servers, such as the first server 120 and the second server 160, the first server 120 may transmit a data transfer request to the second server 160 over the network 130. The data transfer request may include the first data amount, the identifier for the first secure logical storage, and/or the identifier for the second secure logical storage.

When the data transfer is successfully transferred, the first server 120 may add the first data amount to the cumulative data transfer amount at step 580. When the first secure logical storage and the second secure logical storage are located on different servers, the second server 160 may likewise add the first data amount to the cumulative data transfer amount stored within the second secure logical storage. In some aspects, when the data transfer is successful, the first server 120 may adjust the first data amount based on a data transfer modifier. The data transfer modifier may be transferred to a secure logical storage associated with a provider of the first server 120.

At step 590, the first server 120 may then notify the resource management application executing on the first computing device 110 and/or the second computing device 150 of the data transfer. In aspects where the second computing device 150 does not have the resource management application, the second computing device 150 may receive a message, such as by email, text, etc. from the first server 120. In some aspects, the second server 160 may transmit the notification to the resource management application executing on the second computing device 150. Following step 590, the example operation 500 may continue at step 530.

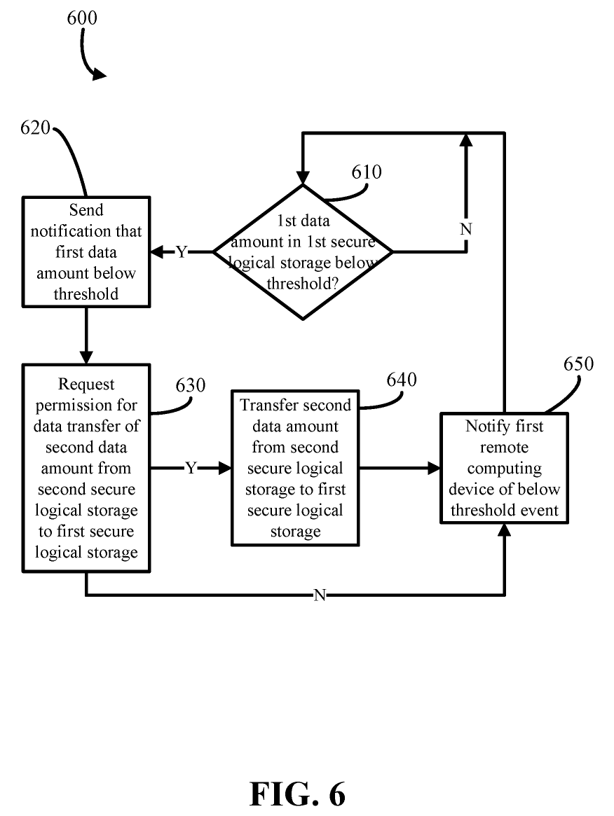

Another example operation 600 is presented in FIG. 6 and involves an automatic transfer of data. In this example, generally, an amount of data in the first secure logical storage may be monitored and when the amount of data falls below a threshold, a second data amount may be transferred from the second secure logical storage to the first secure logical storage to maintain a predetermined amount of data within the first secure logical storage. The predetermined amount of data may be specified in the data access request and approved by the second computing device 150 in the data access authorization as previously described.

At step 610, the amount of data in the first secure logical storage may be periodically monitored, such as on a daily, weekly, and/or monthly basis. When the amount of data in the first secure logical storage is below the threshold, a notification may be sent at step 620 to the first computing device 110 and/or the second computing device 150. In some aspects, the cumulative data transfer limit and the cumulative data transfer amount may be verified as was previously described with reference to FIG. 5 to include the cumulative data transfer limit and the cumulative data transfer amount in the notification. In some aspects, the first server 120 may perform a security analysis of the data transfer request, the data access request, and/or the data access authorization to determine one or more outlier data operation events. In instances where the data transfer request fails the security analysis, the data transfer request is refused and the first computing device 110 and/or the second computing device 150 may be notified.

The notification to the second computing device 150 may request permission, at step 630, for a data transfer of a second data amount from the second secure logical storage to the first secure logical storage. The first server 120 may place the request for permission into an internal permission queue of outstanding requests for permission. In other aspects, the first server 120 may be pre-authorized to perform the transfer bypassing requesting permission. The pre-authorization may be previously provided in the data access request and/or data access authorization.

When the first server 120 receives an authorization from the second computing device 150, the first server 120 may transfer the second data amount from the second secure logical storage to the first secure logical storage at step 640. In instances where the first secure logical storage and the second secure logical storage are both on the first server 120, the first server 120 may perform the transfer. In instances where the first secure logical storage is on the first server 120 and the second secure logical storage is on the second server 160, the first server 120 may form a secure connection over the network 130 to perform the transfer. The first server 120 may provide the second server 160 with the data access request and/or data access authorization. In other aspects, the second server 160 may retrieve the data access request and/or data access authorization from the second secure logical storage. The second data amount may correspond to a multiple of the threshold. For example, the second data amount may be one times the threshold, two times the threshold, three times the threshold, and so forth. In some aspects, the first server 120 may calculate a sum of the first data amount and the second data amount to ensure that the sum is greater than or equal to the threshold.

The first server 120 may send a notification to the first computing device 110 at step 650 notifying the first computing device 110 of the data amount being lower than the threshold and an action taken, such as performing the data transfer from the second secure logical storage to the first secure logical storage. In some aspects, when the data transfer is successful, the first server 120 may adjust the second data amount based on a data transfer modifier. The data transfer modifier may be transferred to a secure logical storage associated with a provider of the first server 120.

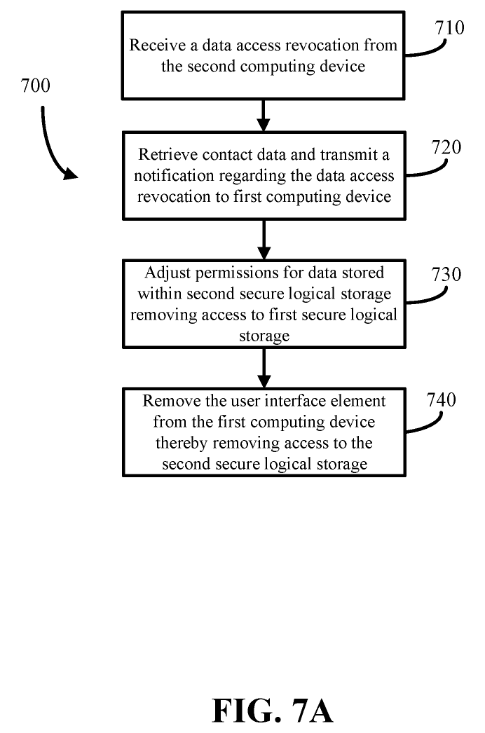

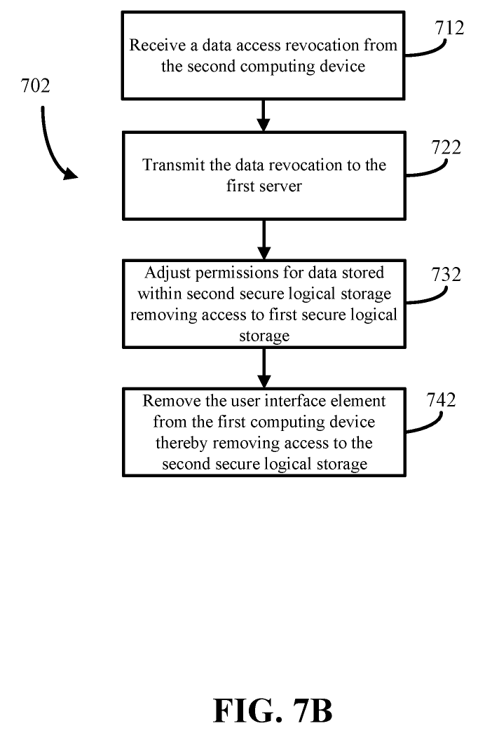

Turning to FIG. 7A, a revocation process 700 is provided and executed by the first server 120 in the instance where the first secure logical storage and the second secure logical storage reside on the first server 120. The second computing device 150 may transfer a data access revocation to the first server 120 at step 710. In some aspects, the second computing device 150 may prepare and transfer the data access revocation within the resource management application executing on the second computing device 150. In other aspects, the second computing device 150 may access a web portal of the first server 120 and provide the data access request and/or the data access authorization associated with the access to the second secure logical storage by the first secure logical storage.

In response to the data access revocation, the first server 120 may retrieve contact data associated with the first secure logical storage and transmit a notification regarding the data access revocation to the first computing device 110 at step 720. The notification may be provided via the network 130 to the resource management application executing on the first computing device 110.

The first server 120 may adjust permissions for the data stored within the second secure logical storage to remove access to the first secure logical storage at step 730. The first server 120 may provide instructions over the network 130 to the resource management application on the first computing device 110 to remove the user interface element for accessing the second secure logical storage at step 740.

Turning to FIG. 7B, a revocation process 702 is provided and executed by the second server 160 in the instance where the first secure logical storage and the second secure logical storage reside on the first server 120 and the second server 160 respectively. The second computing device 150 may transfer a data access revocation to the second server 160 at step 712. In some aspects, the second computing device 150 may prepare and transfer the data access revocation within the resource management application executing on the second computing device 150. In other aspects, the second computing device 150 may access a web portal of the second server 160 and provide the data access request and/or the data access authorization associated with the access to the second secure logical storage by the first secure logical storage.

In response to the data access revocation, the second server 160 may transmit the data revocation to the first server. The first server 120 may retrieve contact data associated with the first secure logical storage and transmit the notification regarding the data access revocation to the first computing device 110. The notification may be provided via the network 130 to the resource management application executing on the first computing device 110. As part of the notification, the first server 120 may provide instructions over the network 130 to the resource management application on the first computing device 110 to remove the user interface element for accessing the second secure logical storage.

The second server 160 may adjust permissions for the data stored within the second secure logical storage to remove access to the first secure logical storage at step 732.

The techniques described herein may be used in open banking to share banking data with a third-party application. For example, banking data may include personal contact information, a bank balance, and transaction history. The data sharing configuration may be configured to share the personal contact information, share the personal contact information and the bank balance, or share the personal contact information, bank balance, and the transaction history.

Example embodiments of the present application are not limited to any particular operating system, system architecture, mobile device architecture, server architecture, or computer programming language.

It will be understood that the applications, modules, routines, processes, threads, or other software components implementing the described method/process may be realized using computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, adaptations and modifications of the described embodiments can be made. Therefore, the above discussed embodiments are illustrative and not restrictive.

What is claimed is:

1. A server comprising:
a communications module;
a processor coupled to the communications module; and
a memory coupled to the processor, the memory storing a plurality of processor-executable instructions which, when executed, configure the processor to:
receive, from a first computing device and via the communications module, a data access request to gain access to a portion of data from a second secure logical storage associated with a second secure logical storage holder by a first secure logical storage associated with a first secure logical storage holder;
transmit the data access request to a second computing device via the communications module;
receive a data access authorization from the second computing device via the communications module, the data access authorization thereby granting access to the portion of the data from the second secure logical storage to the first secure logical storage; and
provide, on the first computing device, a user interface element that, when activated, accesses the portion of the data associated with the second secure logical storage within the first secure logical storage after the data access authorization.

2. The server of claim 1, wherein the processor-executable instructions further configure the processor to:
receive, from the second computing device, a cumulative data transfer limit associated with the first secure logical storage within the second secure logical storage; and
allocate a cumulative data transfer amount associated with the first secure logical storage within the second secure logical storage.

3. The server of claim 2, wherein the processor-executable instructions further configure the processor to:
receive, from the first computing device, a data transfer request of a first data amount from the second secure logical storage to the first secure logical storage.

4. The server of claim 3, wherein the processor-executable instructions further configure the processor to:
determine an outlier data operation event associated with the second secure logical storage for the data transfer request noncompliant with the data access request and the data access authorization; and
notify the first computing device of the outlier data operation event.

5. The server of claim 3, wherein the processor-executable instructions further configure the processor to:
determine when adding the first data amount to the cumulative data transfer amount exceeds the cumulative data transfer limit;
in response to the cumulative data transfer limit not being exceeded, transfer the first data amount from the second secure logical storage to the first secure logical storage and add the first data amount to the cumulative data transfer amount.

6. The server of claim 5, wherein the processor-executable instructions further configure the processor to:
reset the cumulative data transfer amount according to a period.

7. The server of claim 5, wherein the processor-executable instructions further configure the processor to:
notify the first computing device and the second computing device about the first data amount being transferred from the second secure logical storage to the first secure logical storage.

8. The server of claim 1, wherein the processor-executable instructions further configure the processor to:
determine when a first data amount in the first secure logical storage is below a threshold;
send, to the second computing device, a notification that the first data amount in the first secure logical storage is below the threshold; and
execute a data transfer of a second data amount from the second secure logical storage to the first secure logical storage in response to a data transfer authorization.

9. The server of claim 8, wherein the processor-executable instructions further configure the processor to:
determine the second data amount to be added to the first data amount to be greater than or equal to the threshold.

10. The server of claim 1, wherein the processor-executable instructions further configure the processor to:
receive, from the second computing device, a data access revocation, from the second secure logical storage, removing access to the portion of the data associated with the second secure logical storage from the first secure logical storage.

11. A computer-implemented method comprising:
receiving, from a first computing device and via a communications module, a data access request to gain access to a portion of data from a second secure logical storage associated with a second secure logical storage holder by a first secure logical storage associated with a first secure logical storage holder;
receiving, from a second computing device and via the communications module, a data access authorization, from the second secure logical storage, approving access to the portion of the data from the second secure logical storage to the first secure logical storage; and
providing a user interface element on the first computing device, that, when activated, accesses the portion of the data associated with the second secure logical storage within the first secure logical storage after the data access authorization.

12. The computer-implemented method of claim 11, further comprising:
receiving, from the second computing device, a cumulative data transfer limit associated with the first secure logical storage within the second secure logical storage; and
allocating a cumulative data transfer amount associated with the first secure logical storage within the second secure logical storage.

13. The computer-implemented method of claim 12, further comprising:
receiving, from the first computing device, a data transfer request of a first data amount from the second secure logical storage to the first secure logical storage.

14. The computer-implemented method of claim 13, further comprising:
determining an outlier data operation event associated with the second secure logical storage for the data transfer request noncompliant with the data access request and the data access authorization; and
notifying the first computing device of the outlier data operation event.

15. The computer-implemented method of claim 13, further comprising:
determining when adding the first data amount to the cumulative data transfer amount exceeds the cumulative data transfer limit;
in response to the cumulative data transfer limit not being exceeded, transferring the first data amount to the second secure logical storage and add the first data amount to the cumulative data transfer amount.

16. The computer-implemented method of claim 15, further comprising:
resetting the cumulative data transfer amount according to a period.

17. The computer-implemented method of claim 15, further comprising:
notifying the first computing device and the second computing device about the first data amount being transferred from the second secure logical storage to the first secure logical storage.

18. The computer-implemented method of claim 11, further comprising:
determining when a first data amount in the first secure logical storage is below a threshold;
sending, to the second computing device, a notification that the first data amount in the first secure logical storage is below the threshold; and
requesting permission for a data transfer of a second data amount from the second secure logical storage to the first secure logical storage.

19. The computer-implemented method of claim 18, further comprising:
determine the second data amount to be added to the first data amount to be greater than or equal to the threshold.

20. The computer-implemented method of claim 11, further comprising:
receiving, from the second computing device, a data access revocation, from the second secure logical storage, removing access to the portion of the data associated with the second secure logical storage from the first secure logical storage.
